(19) United States
(12) Patent Application Publication
(10) Pub. No.: US 2009/0225324 A1
(43) Pub. Date: Sep. 10, 2009

(54) APPARATUS FOR PROVIDING ENDOSCOPIC HIGH-SPEED OPTICAL COHERENCE TOMOGRAPHY

(75) Inventors: Jonathan J. Bernstein, Medfield, MA (US); Fran J. Rogomentich, Wilmington, MA (US); Ki Hean Kim, Pohang (KR); Tom W. Lee, Wilmington, MA (US); Joahnnes F. De Boer, Amstelveen (NL); James A. Burns, Dover, MA (US)

Correspondence Address: DORSEY & WHITNEY LLP;INTELLECTUAL PROPERTY DEPARTMENT, 250 PARK AVENUE, NEW YORK, NY, 10177, US

(73) Assignee: The General Hospital Corporation, Boston, MA (US)

(21) Appl. No.: 12/356,386

(22) Filed: Jan. 20, 2009

Related U.S. Application Data
(60) Provisional application No. 61/021,829, filed on Jan. 17, 2008.

(51) Int. Cl. G01B 9/02

(52) U.S. Cl. 356/479

(57) ABSTRACT

Exemplary embodiments of an apparatus can be provided which can include at least one first arrangement which is configured to generate a magnetic field. Further, the exemplary apparatus can include at least one second arrangement coupled to the first arrangement(s) and configured to receive at least one first electro-magnetic radiation from a sample to generate at least one second electro-magnetic radiation. The second arrangement(s) can include at least one surface that is at least partially reflective, and the magnetic field can control a motion of the at least one surface. At least one third interferometric arrangement can also be provided which is configured to receive the second electro-magnetic radiation(s) from the second arrangement(s) and at least one third electro-magnetic radiation from a reference. Further, it is possible for the second electro-magnetic radiation(s) to effect a structure of the sample.

### CROSS-REFERENCE TO RELATED APPLICATION(S)

The present invention relates to U.S. Provisional Application No. 61/021,829 filed Jan. 17, 2008, the entire disclosure of which is incorporated herein by reference.

### STATEMENT REGARDING FEDERALLY-SPONSORED RESEARCH

The invention was developed in part with the U.S. Government support from the National Institute of Health under Grant Number NIH-NCRR RO1-RR-019768 and the Department of the Army under Grant Number DAMD17-02-2-0006. Thus, the U.S. Government may have some right to the invention.

### FIELD OF THE INVENTION

The present invention relates to the field of optical coherence tomography, and more particularly, to an exemplary apparatus for providing endoscopic high-speed optical coherence tomography such as, e.g., a two-axis magnetically-driven microelectro-mechanical systems (MEMS) scanning catheter for endoscopic high-speed optical coherence tomography.

### BACKGROUND INFORMATION

References are being made below to various publication which are listed, the entire disclosures of which is incorporated herein.

Optical coherence tomography (OCT) is an optical imaging technique configured to provide cross-sectional imaging of biological tissues based on light scattering. (See D. Huang et al., “Optical coherence tomography,” Science 254, 1178-1181 (1991); and J. G. Fujimoto, “Optical coherence tomography for ultrahigh resolution in vivo imaging,” Nat. Biotechnol. 21, 1361-1367 (2003)). Scattered light is resolved in depth using low coherence interferometry. With its high sensitivity, high resolution, and non-invasiveness, OCT has become an important technique for in vivo clinical diagnosis in opthalmology (see J. G. Fujimoto, “Optical coherence tomography for ultrahigh resolution in vivo imaging,” Nat. Biotechnol. 21, 1361-1367 (2003); J. S. Schuman et al., “Optical coherence tomography: a new tool for glaucoma diagnosis,” Current Opinion in Opthalmology 6, 89-95 (1995); and E. A. Swanson et al., “High-speed optical coherence domain reflectometry,” Opt. Lett. 17, 151-153 (1992)) and dermatology (see J. Welzel, “Optical coherence tomography in dermatology: a review,” Skin Research and Technology 7, 1-9 (2001), <Go to ISI>://000166541600001; B. H. Park et al., “In vivo burn depth determination by high-speed fiber-based polarization sensitive optical coherence tomography,” J. Biomed. Opt. 6, 474-479 (2001); M. C. Pierce et al., “Collagen denaturation can be quantified in burned human skin using polarization-sensitive optical coherence tomography” Burns 30, 511-517 (2004); and M. C. Pierce et al., “Advances in optical coherence tomography imaging for dermatology” J. Invest. Dermatol. 123, 458-463 (2004)).

Development of scanning catheters has facilitated an endoscopic OCT imaging of internal organs and extended the OCT study field further. (See G. J. Tearney et al., “In vivo endoscopic optical biopsy with optical coherence tomography,” Science 276, 2037-2039 (1997); and Z. Yaqoob, J. Wu et al., “Methods and application areas of endoscopic optical coherence tomography,” J. Biomed. Opt. 11, 063001 (2006)). Endoscopic OCT imaging procedures provide an ability to resolve layered tissue structures, and to differentiate normal from certain pathologic conditions within the esophagus (see M. V. J. Sivak et al., “High-resolution endoscopic imaging of the GI tract using optical coherence tomography,” Gastrointest. Endosc. 51, 474-479 (2000); S. Brand et al., “Optical coherence tomography in the gastrointestinal tract,” Endoscopy 32, 796-803 (2000); J. M. Poneros et al., “Diagnosis of specialized intestinal metaplasia by optical coherence tomography,” Gastroenterology 120, 7-12 (2001); B. E. Bouma et al., “High-resolution imaging of the human esophagus and stomach in vivo using optical coherence tomography,” Gastrointest. Endosc. 51, 467-474 (2000); S. Jackle et al., “In vivo endoscopic optical coherence tomography of esophagitis, Barrett's esophagus, and adenocarcinoma of the esophagus,” Endoscopy 32, 750-755 (2000); and X. D. Li et al., “Optical coherence tomography: advanced technology for the endoscopic imaging of Barrett's esophagus,” Endoscopy 32, 921-930 (2000)), coronary artery (see H. Yabushita et al., “Characterization of human atherosclerosis by optical coherence tomography,” Circulation 106, 1640-1645 (2002); O. A. Meissner et al., “Intravascular optical coherence tomography: comparison with histopathology in atherosclerotic peripheral artery specimens,” J. Vasc. Interv. Radiol. 17, 343-349 (2006); and G. J. Tearney et al., “Optical coherence tomography for imaging the vulnerable plaque,” J. Biomed. Opt. 11, 021002 (2006)), and other internal organs such as the oral cavity (see F. I. Feldchtein et al., “In vivo OCT imaging of hard and soft tissue of the oral cavity,” Opt. Express 3, 239-250 (1998)), larynx (see A. V. Shakhov et al., “Optical coherence tomography monitoring for laser surgery of laryngeal carcinoma,” J. Surg. Oncol. 77, 253-258 (2001); B. J. Wong et al., “In vivo optical coherence tomography of the human larynx: normative and benign pathology in 82 patients,” Laryngoscope 115, 1904-1911 (2005); and A. M. Klein, et al., “Imaging the human vocal folds in vivo with optical coherence tomography: a preliminary experience,” Ann. Otol. Rhinol. Laryngol. 115, 277-284 (2006)), and bladder (see E. V. Zagaynova et al., “In vivo optical coherence tomography feasibility for bladder disease,” J. Urol. 167, 1492-1496 (2002).

A development of OCT catheters is important for endoscopic OCT imaging. Conventional OCT catheters are composed of a single-mode optical fiber and small optical elements fused at the tip of the fiber to deflect and focus light onto a tissue. (See G. J. Tearney et al., “Scanning single-mode fiber optic catheter-endoscope for optical coherence tomography,” Opt. Lett. 21, 543-545 (1996); B. E. Bouma and G. J. Tearney, “Power-efficient nonreciprocal interferometer and linear-scanning fiber-optic catheter for optical coherence tomography,” Opt. Lett. 24, 531-533 (1999); and V. X. D. Yang et al., “High speed, wide velocity dynamic range Doppler optical coherence tomography (Part III): in vivo endoscopic imaging of blood flow in the rat and human gastrointestinal tracts,” Opt. Express 11, 2416-2424 (2003), http://www.opticsinfobase.org/abstract.cfm?URI=oe-11-19-2416).

Such fiber assembly is housed in a flexible hollow shaft and can either translate or rotate by actuations at the proximal end. For imaging of tubular organs such as the gastrointestinal (GI) tract and vasculature, these catheters do circumferential scanning by rotation. These catheters are also used to image non-tubular organs by longitudinal translation. (See A. M. Klein et al., “Imaging the human vocal folds in vivo with optical coherence tomography: a preliminary experience,” Ann. Otol. Rhinol. Laryngol. 115, 277-284 (2006); and B. E. Bouma and G. J. Tearney, “Power-efficient nonreciprocal interferometer and linear-scanning fiber-optic catheter for optical coherence tomography,” Opt. Lett. 24, 531-533 (1999)). These conventional OCT catheters are small in size and flexible with their simple structure, and have been used for clinical studies.

A development of spectral domain OCT (SD-OCT) procedures or Fourier domain OCT (FD-OCT) procedures has increased the sensitivity by orders of magnitude (see T. Mitsui, “Dynamic range of optical reflectometry with spectral interferometry,” Japanese Journal of Applied Physics Part 1-Regular Papers Short Notes & Review Papers 38, 6133-6137 (1999), <Go to ISI>://000083622000084; R. Leitgeb et al., “Performance of fourier domain vs. time domain optical coherence tomography,” Opt. Express 11, 889-894 (2003), http://www.opticsinfobase.org/abstract.cfm?URI=oe-11-8-889; J. F. de Boer et al., “Improved signal-to-noise ratio in spectral-domain compared with time-domain optical coherence tomography,” Opt. Lett. 28, 2067-2069 (2003); and M. A. Choma et al., “Sensitivity advantage of swept source and Fourier domain optical coherence tomography,” Opt. Express 11, 2183-2189 (2003), http://www.opticsinfobase.org/abstract.cfm?URI=oe-11-18-2183), which in turn has improved image acquisition speeds by more than an order of magnitude compared to conventional time domain OCT (TD-OCT) techniques. (See N. Nassif et al., “In vivo human retinal imaging by ultrahigh-speed spectral domain optical coherence tomography,” Opt. Lett. 29, 480-482 (2004); and N. A. Nassif et al., “In vivo high-resolution video-rate spectral-domain optical coherence tomography of the human retina and optic nerve,” Opt. Express 12, 367-376 (2004), http://www.opticsinfobase.org/abstract.cfm?URI=oe-12-3-367).

Alternatively, the wavelength resolved interference fringes can be detected using high performance wavelength-swept light sources and can be referred to optical frequency domain imaging (OFDI) or swept-source OCT procedures/systems. (See S. H. Yun et al., “High-speed optical frequency-domain imaging,” Opt. Express 11, 2953-2963 (2003), http://www.opticsinfobase.org/abstract.cfm?URI=oe-11-22-2953; S. R. Chinn et al., “Optical coherence tomography using a frequency-tunable optical source,” Opt. Lett. 22, 340-342 (1997); M. A. Choma et al., “Swept source optical coherence tomography using an all-fiber 1300-nm ring laser source,” J. Biomed. Opt. 10, 044009 (2005); and R. Huber, M. Wojtkowski and J. G. Fujimoto, “Fourier Domain Mode Locking (FDML): A new laser operating regime and applications for optical coherence tomography,” Opt. Express 14, 3225-3237 (2006), http://www.opticsinfobase.org/abstract.cfm?URI=oe-14-8-3225). These fast acquisition procedures/systems facilitate high-speed endoscopic imaging.

Conventional OCT catheters can be used for high-speed imaging of tubular organs, because their circumferential scanning can run at high speeds. Volumetric imaging of the esophagus and coronary artery was demonstrated by using an OCT catheter which rotates continuously with a rotary junction during slow longitudinal translation for 2D scanning. (See S. H. Yun et al., “Comprehensive volumetric optical microscopy in vivo,” Nat. Med. 12, 1429-1433 (2006)). However, for imaging non-tubular organs, conventional catheters scanning linearly may be limited in scanning speed to a few frames/s due to various factors including large inertia, friction, and compliance related to proximal actuation. Furthermore, these translational catheters likely only generate two-dimensional images by scanning along a single axis. Therefore, the conventional OCT catheters limit the ability to perform high-speed three-dimensional imaging of non-tubular organs.

Various OCT catheters have been developed such as side-looking, front-looking, proximal-actuated, distal-actuated and/or fine needle catheters, etc. (See Z. Yaqoob et al., “Methods and application areas of endoscopic optical coherence tomography,” J. Biomed. Opt. 11, 063001 (2006)). Distal-actuated catheters are based on either miniaturized actuators (see P. H. Tran et al., “In vivo endoscopic optical coherence tomography by use of a rotational microelectromechanical system probe,” Opt. Lett. 29, 1236-1238 (2004); P. R. Herz et al., “Micromotor endoscope catheter for in vivo, ultrahigh-resolution optical coherence tomography,” Opt. Lett. 29, 2261-2263 (2004); and X. Liu et al., “Rapid-scanning forward-imaging miniature endoscope for real-time optical coherence tomography,” Opt. Lett. 29, 1763-1765 (2004)) or microelectro-mechanical systems (MEMS) technology (see Y. T. Pan et al., “Endoscopic optical coherence tomography based on a microelectromechanical mirror,” Opt. Lett. 26 1966-1968 (2001); A. Jain et al., “A two-axis electrothermal micromirror for endoscopic optical coherence tomography,” IEEE J. Sel. Top. Quantum Electron. 10, 636-642 (2004); W. Jung et al., “Three-dimensional endoscopic optical coherence tomography by use of a two-axis microelectromechanical scanning mirror,” Appl. Phys. Lett. 88, 163901 (2006); W. Jung, J. Zhang et al., “Three-dimensional optical coherence tomography employing a 2-axis microelectromechanical scanning mirror,” IEEE J. Sel. Top. Quantum Electron. 11, 806-810 (2005); A. D. Aguirre et al., “Two-axis MEMS scanning catheter for ultrahigh resolution three-dimensional and en face Imaging,” Opt. Express 15, 2445-2453 (2007), http://www.opticsinfobase.org/abstract.cfm?URI=oe-15-5-2445; J. T. W. Yeow et al., “Micromachined 2-D scanner for 3-D optical coherence tomography,” Sens. Actuators A. 117, 331-340 (2005); J. M. Zara and P. E. Patterson, “Polyimide amplified piezoelectric scanning mirror for spectral domain optical coherence tomography,” Appl. Phys. Lett. 89, 263901 (2006); and T. Mitsui et al., “A 2-axis optical scanner driven non-resonantly by electromagnetic force for OCT imaging,” J. Micromech. Microeng. 16, 2482-2487 (2006)).

These exemplary catheters generally can scan in two-dimensional (2D) for three-dimensional (3D) imaging and can scan at high speeds. MEMS technology may be able to produce integrated miniaturized actuators for scanning catheters. MEMS-based scanning catheters have been developed with various actuation mechanisms such as electrothermal (see Y. T. Pan et al., “Endoscopic optical coherence tomography based on a microelectromechanical mirror,” Opt. Lett. 26 1966-1968 (2001); and A. Jain et al., “A two-axis electrothermal micromirror for endoscopic optical coherence tomography,” IEEE J. Sel. Top. Quantum Electron. 10, 636-642 (2004)), electrostatic (see W. Jung et al., “Three-dimensional endoscopic optical coherence tomography by use of a two-axis microelectromechanical scanning mirror,” Appl. Phys. Lett. 88, 163901 (2006); W. Jung et al., “Three-dimensional optical coherence tomography employing a 2-axis microelectromechanical scanning mirror,” IEEE J. Sel. Top. Quantum Electron. 11, 806-810 (2005); A. D. Aguirre et al., “Two-axis MEMS scanning catheter for ultrahigh resolution three-dimensional and en face Imaging,” Opt. Express 15, 2445-2453 (2007), http://www.opticsinfobase.org/abstract.cfm?URI=oe-15-5-2445; and J. T. W. Yeow et al., “Micromachined 2-D scanner for 3-D optical coherence tomography,” Sens. Actuators A. 117, 331-340 (2005)), polyimide amplified piezoelectric (see J. M. Zara and P. E. Patterson, “Polyimide amplified piezoelectric scanning mirror for spectral domain optical coherence tomography,” Appl. Phys. Lett. 89, 263901 (2006)), and magnetic (see T. Mitsui et al., “A 2-axis optical scanner driven non-resonantly by electromagnetic force for OCT imaging,” J. Micromech. Microeng. 16, 2482-2487 (2006)) actuation. One-axis and two-axis electrothermal actuated scanners based on bimorph thermal actuator hinges have been implemented. Electrostatic actuated scanners have been used as they offer low mass, low power consumption, absence of exotic materials, and the possibility of built-in capacitive feedback.

Two-axis electrostatic actuators using electrostatic comb-drive actuators can provide three-dimensional tissue imaging. (See W. Jung et al., “Three-dimensional endoscopic optical coherence tomography by use of a two-axis microelectromechanical scanning mirror,” Appl. Phys. Lett. 88, 163901 (2006); W. Jung et al., “Three-dimensional optical coherence tomography employing a 2-axis microelectromechanical scanning mirror,” IEEE J. Sel. Top. Quantum Electron. 11, 806-810 (2005); and A. D. Aguirre et al., “Two-axis MEMS scanning catheter for ultrahigh resolution three-dimensional and en face Imaging,” Opt. Express 15, 2445-2453 (2007), http://www.opticsinfobase.org/abstract.cfm?URI=oe-15-5-2445). However, these comb-drive actuators generally use small gaps and high driving voltages (e.g., ˜100V), with their potential failure being a concern for patient safety. The magnetically-actuated scanner can achieve large scanning ranges with low driving voltages across large gaps, which can be advantageous for scanning catheters. A large size two-axis magnetically-actuated scanner has been implemented instead of x-y galvanometric scanner pairs, but not for endoscopic scanning catheters. (See T. Mitsui et al., “A 2-axis optical scanner driven non-resonantly by electromagnetic force for OCT imaging,” J. Micromech. Microeng. 16, 2482-2487 (2006)). Distal-actuated catheters are likely relatively large in size compared to the conventional OCT catheters, and many of the MEMS-based scanning catheters are at prototype stages.

Further, although magnetic actuation generally use separate wired coils, small coils may be provided, and the assembled catheter measured may be about 2.8 mm in outer diameter. One of the disadvantages of the small size catheters has been that the scanning lengths of such catheters generally decreases with the reduction of outer diameter given a fixed scanning angle.

Conventional endoscopic OCT systems generally utilize slow translation-based scanning devices in combination with slow time domain OCT systems, e.g., running at approximately 1 frames per second. Recent developments of high-speed OCT systems provide an increased imaging speed by more than factor of about ten, and also provide rotating endoscopic probes for high-speed 3D imaging. However, such probes are generally applicable to the imaging of cylindrical-shaped tubular organs only. It still has remained a challenge to provide an OCT system to image asymmetric shaped organs at high speeds. Further, conventional laser treatment methods are likely not incorporated with OCT systems, and the extent of the lesion or treatment is determined based on wide field imaging. Further, in the prior art, there is no known cost effective ways to perform the treatment with a precise position control. The new high-speed MEMS based scanning probe can facilitate rapid imaging of large 3D tissue volumes.

One of the objects of the present invention is to reduce or address the deficiencies and/or limitations of the prior art procedures and systems described above.

### OBJECTS AND SUMMARY OF EXEMPLARY EMBODIMENTS

Accordingly, it may be beneficial to provide an exemplary embodiment of an apparatus for providing endoscopic high-speed optical coherence tomography such as, e.g., a two-axis MEMS micro-mirror scanning catheter according to the present invention which can be actuated by, e.g., a magnetic field for endoscopic SD-OCT imaging. This exemplary embodiment of the MEMS arrangement according to the present invention can be actuated either statically (i.e. below resonance) or at its resonant frequency (e.g., typically between 100 and 1000 Hz). Therefore, the exemplary implementation of high-speed endoscopic OCT imaging procedures may be effectuated using this exemplary catheter.

For example, the exemplary embodiment of a scanner according to the present invention can have a scanning range of about ±20° in optical angle in both axes with low driving voltages (e.g., 1˜3 V). According to one exemplary embodiment of the present invention, the catheter can have an outer diameter of about 2.8 mm, with a rigid body length of about 12 mm. The design of the exemplary embodiments of the MEMS scanner, exemplary optical and mechanical designs of the catheter, and in vivo three-dimensional exemplary images of fingertips and oral cavity tissue obtained using an exemplary multi-functional SD-OCT system are described herein.

Another exemplary embodiment of a two-axis scanning catheter can be provided for three-dimensional endoscopic imaging with spectral domain optical coherence tomography (SD-OCT). The exemplary catheter can incorporate a micro-mirror scanner implemented with microelectromechanical systems (MEMS) technology. The micro-mirror may be mounted on a two-axis gimbal comprised of folded flexure hinges and is actuated by magnetic field. The exemplary scanner can run either statically in both axes (e.g., below resonance) or at the resonant frequency (e.g., typically between 50 and 5000 Hz) for the fast axis. The assembled exemplary catheter may have an outer diameter of about 2.8 mm and a rigid part of about 12 mm in length. The scanning range of the exemplary catheter can be ±about 20° in optical angle in both axes with low voltages (e.g., 1˜3V). This can result in a scannable length of approximately 1 mm at the surface in both axes, even with the small catheter size. The exemplary catheter may be incorporated with a multi-functional SD-OCT system for three-dimensional endoscopic imaging. Both intensity and polarization-sensitive images can be acquired simultaneously at, e.g., about 18.5K axial scans/s.

It is one of the objects of the exemplary embodiments of the present invention to resolve the issue described above with respect to the resonant vibration. Magnetic actuation requires low voltages (1˜3 V), but with somewhat large currents. For example, the power consumed in the catheter can be estimated to be approximately 150 mW by driving both axes. The temperature of the body of the exemplary embodiment of the catheter can be approximately 45° C. due to small body size and thin electrical wires. More beneficial heat sinking may be obtained for larger scanning ranges in the next generation catheter. Additional metal wires can be connected to the catheter body for a heat dissipation, such that certain mechanical rigidity which is preferable for a catheter operation can be obtained. Further, the power consumption can be reduced by moving the coils closer to the mirror.

The exemplary embodiments of the catheter may be used for in vivo endoscopic tissue imaging by incorporating it with a multi-functional SD-OCT system. For example, this exemplary embodiment of the catheter is ready for clinical study of endoscopic tissue imaging, such as the human vocal folds, as well as the vocal folds of anaesthetized patients in the operating room.

According to another exemplary embodiment of the present invention, it may be possible to provide an endoscopic system based on a miniaturized scanning probe. The exemplary probe can have a scanning mirror at the tip, which may be fabricated based on MEMS technology. Such exemplary probe can scan the beam of light in a 2D pattern for imaging or laser treatment. For imaging, the probe may be integrated with a high-speed OCT system, allowing it to be used to image an internal tissue in 3D for diagnosis. The exemplary probe can also be combined with commercial endoscopes in order to navigate to internal organs, and/or used as a light treatment device in addition to 3D imaging. The exemplary embodiment of the system can determine the extent of treatment region based on 3D OCT imaging, so that it can perform a selective and precise treatment. Such treatment can include tissue treatment procedures such as photodynamic therapy using photoactivated sensitizers or drugs, arrangements to kill, ablate or coagulate diseased tissue or blood vessels by photothermal, photochemical or other means, or remove tattoos.

According to the exemplary embodiments of the present invention, it is possible to perform a diagnosis of, e.g., lesions based on the OCT imaging of subsurface tissue structures and the precise laser treatment guided by the OCT imaging. Contrary to conventional scanning probes, whose usage is limited to tubular organs, the exemplary probe images tissues by gently contacting onto the tissue and can be applied to organs in any shape. The exemplary embodiment probe may be small enough to be used in combination with commercial endoscopes in order to access internal organs.

According to exemplary embodiments of the present invention, an apparatus can be provided which can include at least one first arrangement which is configured to generate a magnetic field. Further, the exemplary apparatus can include at least one second arrangement coupled to the first arrangement(s) and configured to receive at least one first electro-magnetic radiation from a sample to generate at least one second electro-magnetic radiation. The second arrangement(s) can include at least one surface that is at least partially reflective, and the magnetic field can control a motion of the at least one surface. At least one third interferometric arrangement can also be provided which is configured to receive the second electro-magnetic radiation(s) from the second arrangement(s) and at least one third electro-magnetic radiation from a reference.

In addition, at least one fourth processing arrangement may be provided which can be configured to generate at least one image of the sample as a function of the second and third electro-magnetic radiations. The first arrangement(s) can generate the magnetic field which may control the surface(s) of the second arrangement(s) to controllably direct the first electro-magnetic radiation(s) to the sample. Further, at least one processing arrangement can be provided which may be configured to generate at least one image of the sample as a function of the controllable directing of the first electro-magnetic radiation(s) to the sample. For example, the image(s) can include at least one of a two-dimensional cross-section or a three-dimensional volume.

According to another exemplary embodiment of the present invention, at least one focusing arrangement can be provided which may be configured to focus the first electro-magnetic radiation(s) and/or at least one second electro-magnetic radiation to generate at least one focused radiation. Such focused radiation(s) can be received by at least one optical fiber. The focusing arrangement(s) can include a GRIN lens which may be connectable to at least one fiber. The GRINS lens may be connected to the fiber(s) using a substance which can match a refractive index of the GRIN lens with a refractive index of the fiber(s).

In still another exemplary embodiment of the present invention, the first and second arrangements can be provided in an endoscope which may include a portion to be inserted into at least anatomical structure, and the portion can be configured to provide the first electro-magnetic radiation(s) to the sample. A further arrangement can be provided which may be configured to provide a particular voltage to the first arrangement(s) so as to generate the magnetic field, and the particular voltage can be less than 10V. The first and second arrangements may be provided through at least one port of the endoscope. Further, the first and second arrangements and the endoscope can be provided in a dual-lumen sheath.

According to yet another exemplary embodiment of the present invention, the first electro-magnetic radiation(s) can have at least one wavelength that changes over time. A further processing arrangement can be provided which may be configured to generate at least one image of the sample as a function of the wavelength(s), the second electro-magnetic radiation(s) and/or the third electro-magnetic radiation(s). At least one detection arrangement can be provided which may include at least one spectrally separating unit which can detect a plurality of wavelengths of at least one further radiation provided by the third interferometric arrangement(s).

One or more processing arrangements can be provided which may be configured to generate at least one image of the sample as a function of the plurality of wavelengths, the second electro-magnetic radiation(s) and/or the third electro-magnetic radiation(s). As an alternative, exemplary processing arrangement(s) can be provided which may be configured to generate at least one image of the sample and provide further radiation for treating at least one portion of the sample being imaged. A multiple-axis mirror arrangement can also be provided. The first arrangement(s) can include a plurality of coils configured to control the multiple-axis mirror arrangement, and the magnetic field can include at least two independent magnetic fields. Further, a microelectro-mechanical systems (MEMS) mirror arrangement and a magnet coupled to the MEMS mirror arrangement can also be provided.

In a further exemplary embodiment of the present invention, an apparatus can be provided which may include at least one first arrangement which is configured to generate a magnetic field, at least one second arrangement coupled to the at least one first arrangement and configured to receive at least one first electro-magnetic radiation from an energy-generating arrangement to generate at least one second electro-magnetic radiation. The second arrangement(s) can includes at least one surface that may be at least partially reflective, and the magnetic field can control a motion of the at least one surface. The second electro-magnetic radiation(s) can effect a structure of the sample.

For example, the second arrangement can receive at least one third electro-magnetic radiation from the sample, and at least one third interferometric arrangement may be provided which can be configured to receive the third electro-magnetic radiation(s) from the second arrangement(s) and at least one fourth electro-magnetic radiation from a reference. At least one processing arrangement can be provided which may be configured to generate at least one image of the sample as a function of the third and fourth electro-magnetic radiations, and to control an amount, a path and/or a location on or in the sample of the second electro-magnetic radiation(s) as a function of at least one characteristic of the image(s). The second and third electro-magnetic radiations can be provided via the surface(s). At least one fourth arrangement can also be provided which may be configured to generate at least one image of the sample and provide further radiation for treating at least one portion of the sample being imaged.

These and other objects, features and advantages of the present invention will become apparent upon reading the following detailed description of embodiments of the invention, when taken in conjunction with the appended claims.

### BRIEF DESCRIPTION OF THE DRAWINGS

Further objects, features and advantages of the invention will become apparent from the following detailed description taken in conjunction with the accompanying figures showing illustrative embodiments of the invention, in which:

FIG. 1(a) is an exemplary optical image of an exemplary embodiment of a MEMS mirror scanner having a supporting folded flexure according to the present invention;

FIG. 1(b) is an exemplary SEM image of an exemplary embodiment of a folded flexure hinge of an exemplary MEMS mirror scanner that is supported by a 2-axis gimbal structure composed of folded flexure hinges and can deflect in two orthogonal axes;

FIGS. 2(a)-2(e) are illustrations of exemplary procedures associated with an exemplary embodiment of an exemplary MEMS scanner fabrication process according to the present invention;

FIG. 3(a) is a cross side view of a schematic diagram of the exemplary embodiment of the catheter according to the present invention;

FIG. 3(b) is a side view of an exemplary illustration of a photograph of the exemplary embodiment of the catheter shown in FIG. 3(a);

FIG. 3(c) is a front view of a tip portion of a conventional endoscope;

FIG. 3(d) is an exemplary illustration of another exemplary embodiment of an endoscopic system which includes an endoscope having therein an exemplary OCT scanning probe protruding through a side port thereof;

FIG. 3(e) is a perspective view of a conventional endoscope with a laser treatment fiber introduced through a working side-port, with which a fine control of the region to be treated may be unlikely;

FIG. 3(f) is an illustration of another exemplary embodiment of the MEMS scanner/probe which can be used with the exemplary OCT system to visualize the target tissue and steer/control the treatment illumination precisely to the desired regions;

FIG. 4 is an exemplary graph of a scanning range of the exemplary embodiment of the MEMS scanner, with the lines therein being linear fits of measurement points;

FIG. 5(a) is an exemplary in-vivo cross-sectional image in the inner axis of a finger tip using the exemplary embodiment of the process and system according to the present invention;

FIG. 5(b) is an exemplary in vivo cross-sectional image of the finger tip in an outer axis using the exemplary embodiment of the process and system according to the present invention;

FIG. 5(c) is a three-dimensional reconstructed image based on the consecutive cross-sectional image in shown in FIG. 5(a);

FIG. 5(d) is an exemplary three-dimensional reconstructed image based on the consecutive cross-sectional image in shown in FIG. 5(b);

FIG. 6(a) is an exemplary cross-sectional intensity image of an internal oral cavity in-vivo which is updated by cross-section advancing in the orthogonal axis in accordance with an exemplary embodiment of the present invention; and

FIG. 6(b) is an exemplary cross-sectional polarization sensitive image of an internal oral cavity in-vivo which is updated by cross-section advancing in the orthogonal axis in accordance with an exemplary embodiment of the present invention.

Throughout the figures, the same reference numerals and characters, unless otherwise stated, are used to denote like features, elements, components or portions of the illustrated embodiments. Moreover, while the subject invention will now be described in detail with reference to the figures, it is done so in connection with the illustrative embodiments. It is intended that changes and modifications can be made to the described embodiments without departing from the true scope and spirit of the subject invention.

### DETAILED DESCRIPTION OF EXEMPLARY EMBODIMENTS

### A. Exemplary Catheter Design

Exemplary MEMS Mirror Scanner

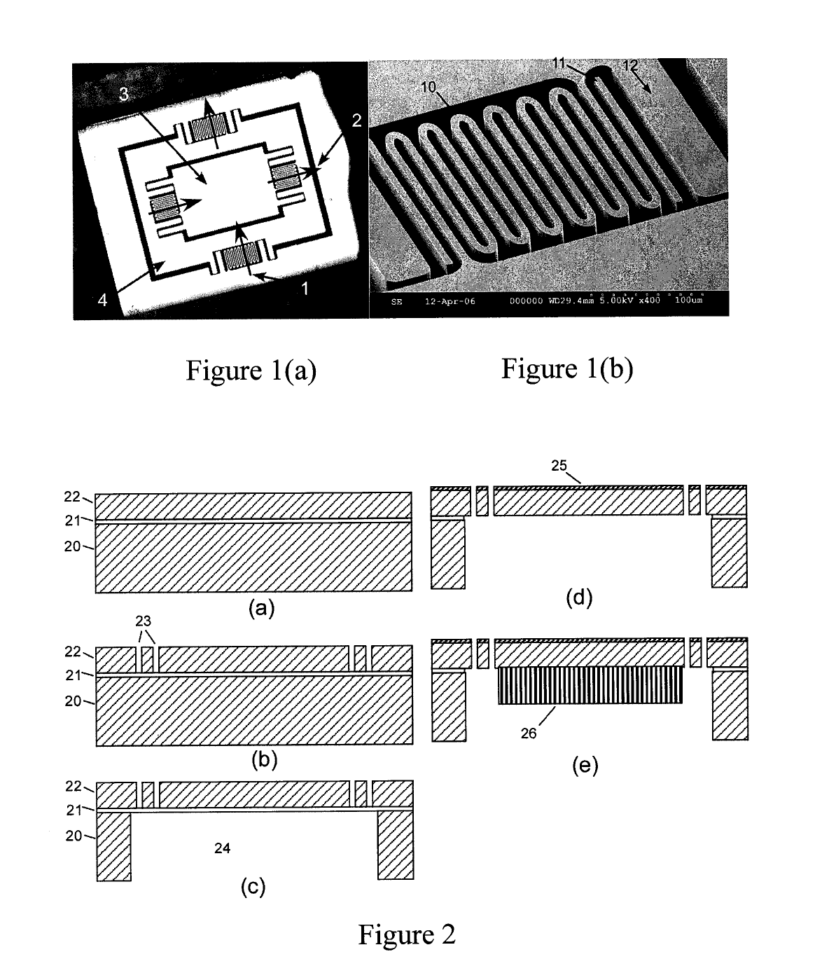

FIG. 1(a) shows an exemplary optical image of an exemplary embodiment of a MEMS mirror scanner having a supporting folded flexure according to the present invention. For example, as shown in the exemplary embodiment shown in FIG. 1(a), a rectangular-shaped micro-mirror 3 is mounted on a two-axis gimbal platform with folded flexure hinges. The micro-mirror can rotate in two axes, e.g., an inner axis 2 along a pair of inner flexures and an orthogonal outer axis 1 along the outer flexure pair. Exemplary dimensions of the mirror can be, e.g., approximately 0.6 mm×0.8 mm in width and height, respectively, and the exemplary dimensions of the entire unit can be, e.g., 2.4 mm×2.9 mm. An exemplary scanning electron micrograph (SEM) 12 according to the exemplary embodiment of the folded flexure according to the present invention is shown in FIG. 1(b). Exemplary flexures 10 can be about 6 microns wide and about 50 microns deep, e.g., providing a preferable out-of-plane stiffness. Exemplary stop 12 is provided to limit in plane motion of the mirror and protect the mirror from damage due to shocks. Exemplary etch buffer 11 is provided to enhance the uniformity of the etch process creating the flexures, and is removed later in the process. For a magnetic actuation, a thin permanent magnet can be glued to the back of the mirror and wire-wound coils are placed in the catheter body for each axis, as further described herein.

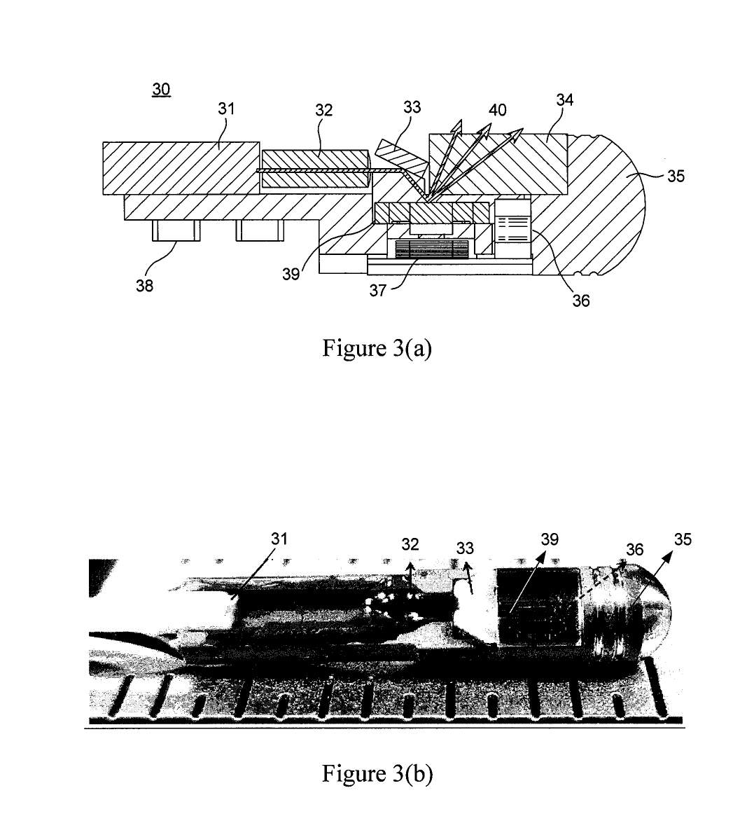

FIGS. 2(a)-2(e) illustrate side views of portions of the device used in an exemplary embodiment of a manufacturing process according to the present invention, e.g., composed of 2 photo-steps/procedures, to produce an exemplary mirror scanner. For example, the starting material can be an SOI (Silicon On Insulator) wafer with approximately a 50 μm thick SOI layer 22 on about 350 μm thick handle wafer 20, with approximately 1 μm thick oxide layer 21 in between the layers 20, 22 (as shown in FIG. 2(a)). Exemplary mirrors and gimbals, including folded flexures, can be formed by ICP (Inductively Coupled Plasma) etching slots 23 in an STS reactor (STS plc, Newport, UK) (as shown in FIG. 2(b)). Following this step/procedure, a handle side may be similarly patterned by ICP etching part of the handle wafer creating a cavity 24 to free them (as shown in FIG. 2(c)). The exposed oxide can be etched using buffered HF (BHF) (as shown in FIG. 2(d)). At this point, the mirrors may be held in the wafer by thin tabs, which can be broken to remove them from the wafer. A Cr/Au layer 25 can then be sputtered on the mirror side of the chip (see FIG. 2(d)). Thin magnet layers, which can be composed of small NdFeB magnets 26, measuring about 0.6 mm×0.8 mm×0.18 mm may be glued to the backs of the mirrors, e.g., manually (see FIG. 2(e)).

These exemplary small magnets can be produced by, e.g., grinding magnet blanks to the desired thickness, dicing to the desired dimensions and then magnetizing. Reducing the mass of the mirror and magnet assembly can be important to increase shock and vibration resistance and possibly limit a mechanical resonance (e.g., a Q factor). Further, thicker magnet layers can provide a higher actuation torque for a given driving current, leading to a possible trade-off between an actuation force and a shock resistance. The rigidity of the folded flexures can be set to balance between large scanning angles and mechanical stability. Resonant frequencies for the inner and outer axes may be approximately 450 Hz and 350 Hz, respectively and generally fall in the range from about 50 Hz to 5 kHz.

Exemplary Catheter Design

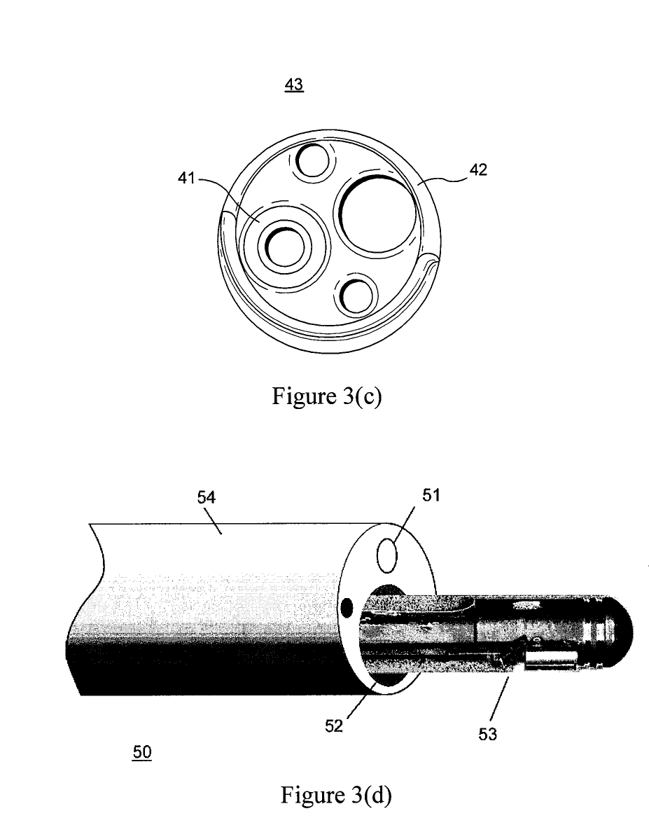

FIGS. 3(a) and 3(b) show an exemplary cross-sectional schematic diagram and an exemplary photograph, respectively, of the exemplary embodiment of an assembled catheter according to the present invention. As shown in the schematic diagram of FIG. 3(a), a light path is illustrated as being provided initially from optical fiber 31 along a horizontal axis through grin lens 32, and then redirected by a fold mirror 33 to an exemplary rotating MEMS scan mirror 39. A light beam 40 can be scanned by the rotating MEMS mirror 39, passing through a plano-convex window 34. Certain exemplary components are mounted in a body 35 which can be made of a non-magnetic material, such as titanium.

Scanning in the outer axis can be controlled by current passing through an outer axis control coil 36 which produces a magnetic field to direct the MEMS mirror 39. While one coil is shown, a coil pair with a coil on opposite sides of the MEMS mirror 39 be provided. It should be understood that more than two coils and more than one MEMS mirror 39 can be utilized. Scanning along the inner axis can be controlled by the current through a further coil pair 37. The photograph of the exemplary catheter is shown in FIG. 3(b) which is provided with a ruler therewith to illustrate the exemplary measurements thereof in millimeters. For example, the optical fiber 31 can be glued to the body of the exemplary catheter with UV curing adhesive. An optical radiation emitted by the exemplary MEMS scanner 39 shown in FIG. 3(a) can be refracted by the plano-convex cylindrical window 34.

Light can be delivered via, e.g., a single mode optical fiber 31 (e.g., Corning SMF-28, core diameter: 8.2 μm) as shown in FIGS. 3(a) and 3(b) from the left thereof. The divergent beam from the optical fiber 31 can be focused by, e.g., a GRIN lens 32 (e.g., NSG America #ILH-0.70, 1.1 mm length, 0.51 mm focal length), and reflected down toward the exemplary MEMS mirror 39 with a fold mirror 33. The faces of the GRIN lens 32 can be angle-polished to avoid back reflection. The MEMS mirror 39 can reflects the beam up toward a specimen through the plano-convex cylindrical glass window 34. The glass window can have an anti-reflection (AR) coating on one or more of its surface(s). The beam focus may be placed within the specimen, which can be in contact with the exemplary catheter according to the present invention. The MEMS mirror 39 may redirect the beam in two orthogonal axes. An outer axis control coil 36 can be painted black with (e.g., Testors flat black enamel) to absorb the scattered light. The scattered light from the tissue returns back through approximately the same optical path, and can be collected by the optical fiber 31.

This exemplary configuration can facilitate the scanning of the beam forward and imaging close to the tip of the exemplary catheter. The glass window can protect the exemplary MEMS scanner, and can maintain the cylindrical catheter shape. The scanning range can be provided to exclude a normal incidence on the glass window in order to avoid strong back-reflections. An exemplary optical design may be optimized via, e.g., ZEMAX simulation (Zemax Development Corp., Bellevue, Wash.) to maintain image resolution throughout the three-dimensional (3D) imaging region. The image resolution may be approximately 25 microns at the Gaussian beam waist in transverse direction, and its Rayleigh range can be approximately 1.5 mm in air (e.g., 3 mm in depth of focus).

A body 35 of the exemplary catheter can be machined of titanium, since it is a strong, non-magnetic material. The rigid housing of the exemplary catheter may be about 2.8 mm in outer diameter with a length of approximately 12 mm. The exemplary coil pair 37 may be provided under the MEMS mirror 39 for a magnetic actuation in the inner axis, and the coil 36 can be placed at the distal tip of the catheter for the actuation in the outer axis. Alternatively or in addition, a pair of coils may be used on distal and proximal sides of the scan MEMS mirror 39 to actuate the outer axis. Although very fine coils may be fabricated by lithography and electroplating, wire-wound coils can also be used as they are commercially available at low costs. Exemplary coils can be wound from, e.g., a #50 AWG wire on temporary winding mandrels.

The outer axis coils can average approximately 390 turns and 35-40 ohms, whereas the smaller inner axis coil pairs may average approximately 18 ohms. The inner axis coil pairs 37 can be mounted on titanium coil supports with small nubs to center the coils 37. These coil supports may be glued to the main body using epoxy or otherwise connected thereto. The coils may also be painted using enamel (Testors Flat Black) to reduce stray light reflections from the body and its coupling to the optical fiber. For strain relief, the fine coil wires may be attached to a small flex circuit board with solder pads using solder or conductive adhesive. For example, four #34 AWG multi-strand wires can be used for external connections. Further, two or more leads may be utilized for each axis of actuation. In order to access internal organs, the exemplary embodiment of the MEMS scanner/probe can be combined with conventional endoscopes which are clinically utilized. FIG. 3(c) shows a front view of a tip portion of such conventional endoscope 43, a Pentax model VNL 1530. A conventional endoscope can have a fiber-bundle imager 41 or a distal chip imager, and an auxiliary or working sideport 42.

As the next exemplary assembly procedure, a single mode optical fiber 31 can be attached to the exemplary catheter. The fiber 31 may be angle cleaved to avoid back-reflection from its tip, and such fiber 31 can be aligned with the catheter body by using, e.g., a precision 3D translator. Alternatively or in addition, a precision ferrule may be used to position the optical fiber. The gap between the tip of the fiber 31 and the GRIN lens 32 in the exemplary catheter may be filled with an ultraviolet (UV) curing adhesive (e.g., Norland 68) for index matching and gluing. It can be beneficial to provide the distance between the fiber tip and the grin lens correctly as this distance may determine the depth location of the beam focus in the sample. As an example, this distance may be adjusted by, e.g., imaging a sample of about 5 μm diameter polystyrene microspheres embedded in agar gel with a conventional TD-OCT system such that the beam maintains focus throughout the entire imaging depth. When this distance is correctly set, the fiber can be fixed in place by curing the adhesive with, e.g., a UV lamp.

Multi-Functional SD-OCT System

The exemplary embodiment of the 2-axis MEMS scanning catheter can be provided in an exemplary multi-functional SD-OCT system, configured to provide simultaneous intensity, polarization-sensitive (PS), and phase-resolved optical Doppler imaging. (See, e.g., B. H. Park et al., “Real-time fiber-based multi-functional spectral-domain optical coherence tomography at 1.3 um,” Opt. Express 13, 3931-3944 (2005), http://www.opticsinfobase.org/abstract.cfm?URI=oe-13-11-3931). An exemplary polarization-sensitive OCT (PS-OCT) procedure can facilitate a depth-resolved measurement of a light-polarization state changing properties of tissue, and may be used for applications including correlating burn depth with a decrease in birefringence (see, e.g., B. H. Park et al., “In vivo burn depth determination by high-speed fiber-based polarization sensitive optical coherence tomography,” J. Biomed. Opt. 6, 474-479 (2001)), e.g., measuring the birefringence of the retinal nerve fiber layer, and monitoring the onset and progression of caries lesions by analyzing depth dependent changes in the polarization state of detected light.

The exemplary PS-OCT imaging procedure can be useful for endoscopic imaging of the vocal folds by providing additional contrast to resolve their layered structures. (See, e.g., A. M. Klein, M. C. Pierce, S. M. Zeitels, R. R. Anderson, J. B. Kobler, M. Shishkov, and J. F. de Boer, “Imaging the human vocal folds in vivo with optical coherence tomography: a preliminary experience,” Ann. Otol. Rhinol. Laryngol. 115, 277-284 (2006); and J. A. Burns et al., “Imaging the mucosa of the human vocal fold with optical coherence tomography” Ann. Otol. Rhinol. Laryngol. 114, 671-676 (2005)). Such exemplary procedure may provide rheological information of the vocal folds based on the level of birefringence.

Phase-resolved optical Doppler tomography can facilitate a depth-resolved imaging of flow by observing differences in phase of a spectral interferogram between successive depth scans. (See, e.g., B. H. Park et al., “Real-time fiber-based multi-functional spectral-domain optical coherence tomography at 1.3 um,” Opt. Express 13, 3931-3944 (2005), http://www.opticsinfobase.org/abstract.cfm?URI=oe-13-11-3931). Such exemplary system(s) can be based on a fiber-based interferometer with a broadband light source centered at about 1.3 μm with a bandwidth of approximately 68 nm at full width half maximum (FWHM). This bandwidth may provide an exemplary coherence length of about 11.27 microns in air. The exemplary 2-axis scanning catheter in the sample arm can be covered with a heat-shrink plastic sheath (FEP, Zeus Inc, Orangeburg, S.C.) and an epoxy glue can be applied to its open end for sealing. Control signals for the exemplary MEMS scanner may be generated by an acquisition computing arrangement, and possibly amplified by a power amplifier (e.g., PA74, Apex Microtech, Tucson, Ariz.) to provide a particular amount of the electrical current (e.g., up to 100 mA) for driving the scanner. The exemplary acquisition speed can be, e.g., about 18,500 axial scans per second.

As shown in FIG. 3(d), a side/working port 52 of an exemplary endoscope 50 can be used to augment and/or facilitate the exemplary embodiment of a MEMS scanning probe 53 according to the present invention with, e.g., conventional imaging components 51, such as a fiber bundle or distal chip imager and/or procedures associated therewith. Alternatively or in addition, an exemplary OCT imager and fiberscope can be combined by threading each into a dual-lumen sheath, e.g., such as are made available by Vision Sciences. It may be beneficial for certain applications to minimize the total diameter of the endoscope. For example, a trans-nasal insertion of the endoscope can restrict the diameter to 5˜6 mm or less. The exemplary OCT scanning probe described herein can have a diameter of, e.g., approximately 3 mm, facilitating such exemplary scanning probe to be combined with a small conventional endoscope for the trans-nasal mode. The trans-nasal insertion can facilitate numerous procedures to be conducted in an office setting without anesthesia, avoiding costly operating room procedures.

The photoangiolytic treatment of lesions can generally use a pulsed laser light whose wavelength has high absorption in blood to, e.g., destroy blood vessels feeding the lesions. A current practice can be to combine a multi-mode fiber carrying the high power laser light with an imaging endoscope via its sideport. A precise positioning of the high power fiber may not be possible, and a precise targeting of the tissue to be treated may not be feasible. FIG. 3(e) illustrates a perspective view of a schematic illustration of a conventional endoscope 60 with an imaging window 62 so as to image a tissue region 63. For the example, such conventional endoscope 60 can include a laser treatment fiber 61 introduced through a working side-port (e.g., the port 51 of FIG. 3(d)), exposing the tissue area 64 to the laser treatment. Using this exemplary arrangement, a fine control of region to be treated may be difficult, if not impossible. A healthy tissue adjacent to the lesions may be unavoidably exposed to high doses of the radiation. For the cases which prefer or require a selective treatment with a better precision, the laser treatment may likely be performed in the operating room under anesthesia. However, such procedure may be risky and expensive.

In contrast, by passing the exemplary treatment laser through the exemplary embodiment of the MEMS scanning scanner/probe according to the present invention, the laser treatment can be guided by an exemplary simultaneous OCT imaging procedure. Therefore, a precise position control of the treatment area can be effectuated using the exemplary embodiments of the systems, arrangements and processes according to the present invention.

FIG. 3(f) shows a perspective view of a schematic illustration of another exemplary embodiment of a system 70 comprising a MEMS scanner/probe 75 which can be used with the exemplary OCT system to visualize the target tissue 78 and steer/control the treatment illumination, e.g., precisely to the desired regions 71. For example, such exemplary scanner/probe 75 can be used for the exemplary mode of operation is to access the internal organ in combination with a commercially available endoscope for imaging and laser treatment. The exemplary steps of operation can include, e.g., (a) navigating to the internal organ and locate the lesion with wide field imaging of the endoscope, (b) performing 3D OCT imaging with the exemplary embodiment of the MEMS scanner/probe 75 for close examination, and (3) performing a selective laser treatment in a selected region 71 based on the OCT image of region 78.

Exemplary Results

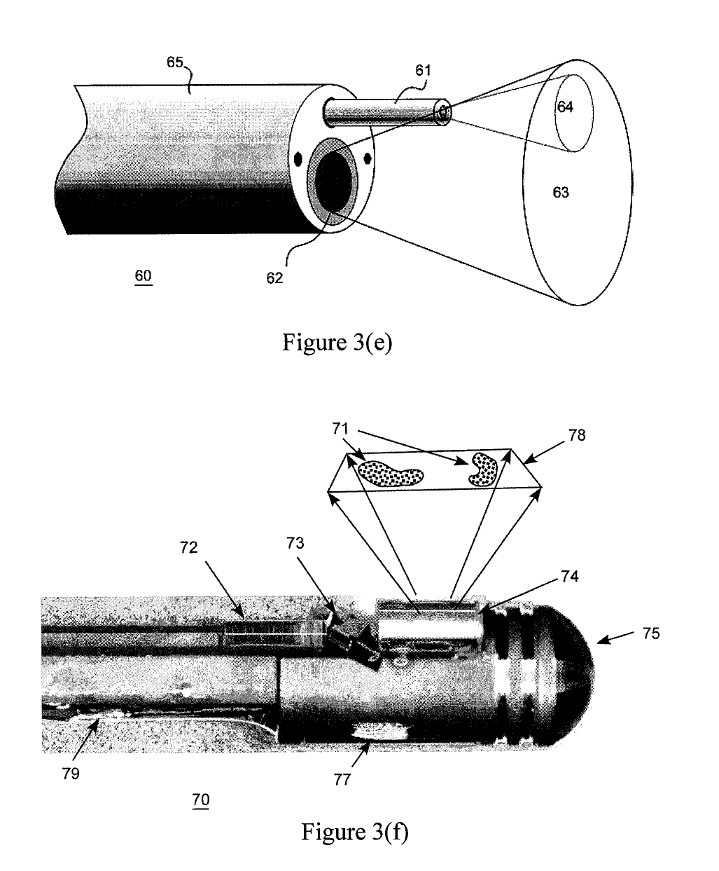

For example, the scanning range of the exemplary embodiment of the MEMS scanner according to the present invention can be measured at an intermediate assembly procedure, before the fold mirror and plano-convex cylindrical window were attached. For example, a laser pointer was used to illuminate the scanner, and the spot positions vs. driving voltages were recorded using a paper screen with 1 mm spaced lines. FIG. 4 shows an exemplary graph 80 of exemplary optical angles of the exemplary MEMS scanner in both an inner axis 82 and an outer axis 81 as opposed to driving voltages. These sample angles scaled nearly linearly with the driving voltages in both axes and the angles higher than ±30° were typically achieved with a voltage level of ±1.2 V and ±4 V for the inner and outer axis respectively. The electrical currents were calculated to be 50 mA and 100 mA for the inner and outer axis respectively by using their resistance values. The outer axis coil was relatively inefficient at applying torque compared to the inner axis coils due to a larger gap between the coil and the magnet on the back of the mirror.

In the exemplary assembled catheter, the optical window refracted the beam, resulting in a slight nonlinearity in the deflection angle with the driving voltage due to thickness variations of the window. At large scan angles spurious vibrations at the mirror resonant frequency were observed. To avoid this vibration, the scan angle was reduced to approximately ±20° optical angle for the inner axis and less than ±about 30° optical angle for the outer axis. Image resolution was measured by imaging microspheres (e.g., 5 microns in diameter) immobilized in agar. Full width at half maximum intensity (FWHM) in lateral direction measured approximately 23 μm on average.

In vivo, 3D endoscopic imaging of tissues was performed by using the exemplary embodiment of the 2-axis scanning catheters and the exemplary embodiment of the multifunctional SD-OCT system in accordance with the present invention. Consecutive cross-sectional images were acquired by using either the inner axis or the outer axis as the fast scanning axis and the other axis as the slow scanning axis. The scanning in the fast axis was driven by a sinusoidal waveform (e.g., about 18.5 Hz) to confirm that the exemplary scanner followed the driving waveform without distortion. The scanning in the slow axis was driven by a linear triangular waveform (e.g., about 0.09 Hz). Each cross-sectional image was taken during a full cycle of the sinusoidal waveform in the fast axis and was composed of about 1024 axial scans. The exemplary cross-sectional image was symmetric with the first half in the forward scanning direction and the second half in the opposite (backward) direction.

Approximately 100 consecutive cross-sectional images were acquired by scanning in the slow axis. A post image processing was performed in Matlab (Mathworks, MA) to generate images and its steps are following: (a) a standard SD-OCT image processing algorithm was applied first to obtain both intensity and PS images; (b) each cross-sectional image, which contained both forward and backward images, was split into two images and incoherently averaged to reduce speckle noise; (c) the cross-sectional images were rescaled linearly in angle by interpolation of the sinusoidal driving waveform in the fast axis, with the resulting images being provided in polar coordinates; and (d) the images in polar coordinates were converted into Cartesian coordinates by a secondary interpolation step.

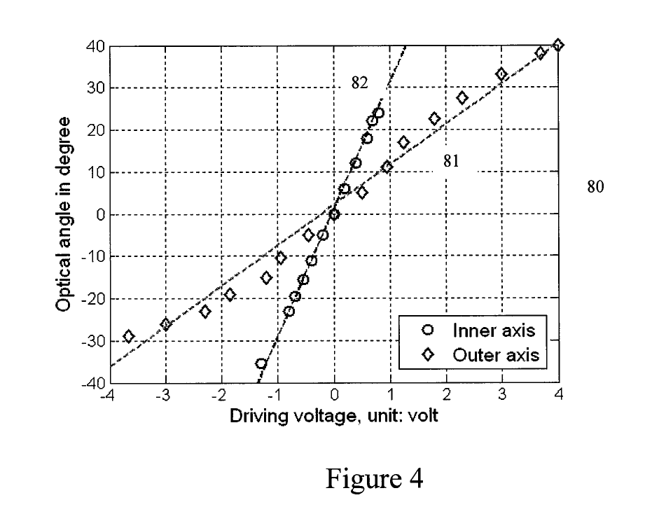

As an initial matter, human fingertips were imaged in vivo and their 3D cross-sectional images are shown in FIGS. 5(a) and 5(b). For example, in FIG. 5(a), exemplary cross-sectional images were acquired by using the inner axis of the scanner as the fast axis with a driving voltage of ±about 0.8V. The boundary of the cross-sectional images can reflect the radial geometry and the large angle (e.g., ±about 20°) of the scan. Its scanning range was approximately 1 mm in length on the surface. The slow (outer) axis was driven with ±1V and its scanning range was about 0.55 mm in length on the surface. Approximately 100 consecutive cross-sectional images were acquired. The total acquisition time was about 5.4 seconds. As shown in FIG. 5(b), the fast and slow scanning axes were switched from those of FIG. 5(a): the outer axis was used as the fast scanning axis and the inner axis as the slow axis.

In this exemplary configuration, the scanning range of approximately 1.5 mm was achieved in the fast axis (outer) and about 1 mm was for the slow (inner) axis. The driving voltage was approximately ±2.8 V and about ±0.8 V for the outer and inner axis respectively. These intensity images were displayed with an inverse gray-scale such that black indicates the highest intensity and white the lowest. Both cross-sectional images shown in FIGS. 5(a) and 5(b) visualized the finger tip structures: the layered structures of the thick epithelium and dermis from superficial to deep, wrinkled fingerprint patterns, and sweat ducts in the epithelium. FIGS. 5(c) and 5(d) show three-dimensional reconstructions of the consecutive cross-sectional images illustrated in FIGS. 5(a) and 5(b), respectively. In particular, FIGS. 5(c) and 5(d) illustrate the exemplary three-dimensional tissue structures including the fingerprint orientation.

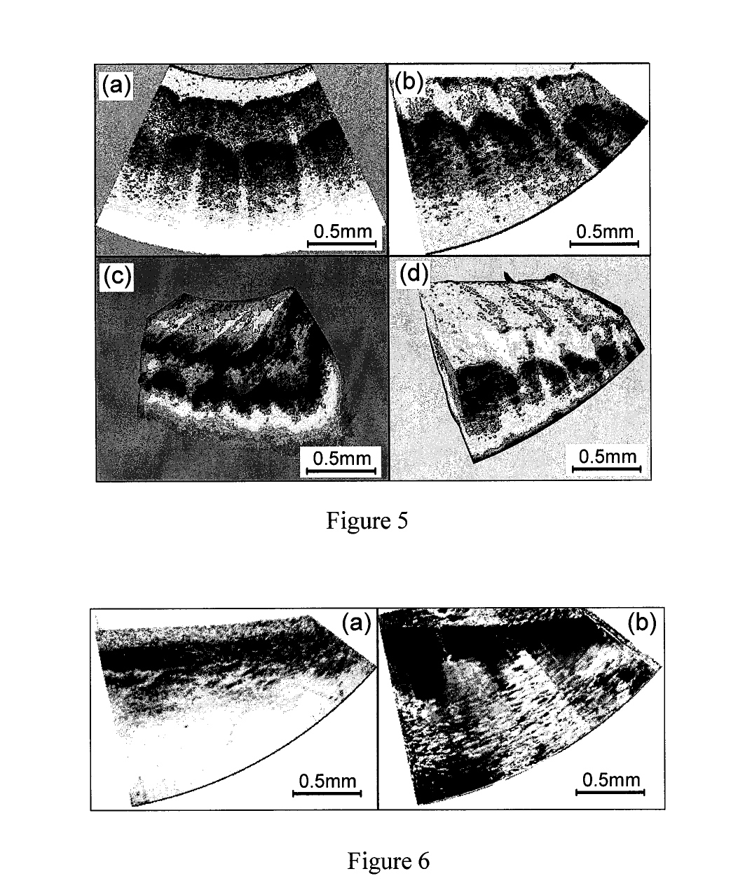

Next, as a demonstration of in vivo endoscopic imaging of internal tissues, oral cavity tissues were imaged. The exemplary three-dimensional imaging procedures was performed using the outer axis as the fast scanning axis and the inner axis as the slow, in order to obtain a large scanning range: approximately 1.5 mm and 1.0 mm on the surface for the fast and slow axis respectively. About 100 consecutive images were acquired with the imaging speed of about 18.5 frames/s and the total imaging time was approximately 5.4 seconds. Both intensity and PS (Polarization Sensitive) images were acquired simultaneously. Consecutive cross-sectional images of both intensity and PS were processed as a movie (see FIGS. 6(a) and 6(b)). In particular, FIGS. 6(a) and 6(b) show intensity and polarization sensitive (PS) images, respectively of cross-sectional images of internal oral cavity in-vivo in accordance with the exemplary embodiment of the present invention. These exemplary images are updated with the cross-section advancing in the orthogonal axis. The exemplary intensity image of FIG. 6(a) shows layered structures of epithelium and glands from superficial to deep, and the exemplary PS image of FIG. 6(b) shows no birefringence in the epithelium and some birefringence in the glands

In particular, the cross-sectional images of FIGS. 6(a) and 6(b) illustrate the oral tissue structures: from the surface to deep, epithelium, a layer of well developed glands, and amorphous layer with some sparse large vessels. For example, the gland layer appeared thin, because the catheter was pressed hard onto the tissue in order to be held stationary during acquisition time and the tissue was squeezed. The PS images of FIG. 6(v), display accumulated phase retardation from the surface, where black indicates 0° phase retardation and white 180°. Further accumulation of phase retardation wraps back around to a black color. The epithelium layer stayed in black with no birefringence and in the layer below the epithelium, the color changed from black to white, indicating some birefringence. Scrambling of black and white at the bottom of the images indicated un-determined polarization states (or noise regime).

The foregoing merely illustrates the principles of the invention. Various modifications and alterations to the described embodiments will be apparent to those skilled in the art in view of the teachings herein. Indeed, the arrangements, systems and methods according to the exemplary embodiments of the present invention can be used with and/or implement any OCT system, OFDI system, SD-OCT system or other imaging systems, and for example with those described in International Patent Application PCT/US2004/029148, filed Sep. 8, 2004 which published as International Patent Publication No. WO 2005/047813 on May 26, 2005, U.S. patent application Ser. No. 11/266,779, filed Nov. 2, 2005 which published as U.S. Patent Publication No. 2006/0093276 on May 4, 2006, and U.S. patent application Ser. No. 10/501,276, filed Jul. 9, 2004 which published as U.S. Patent Publication No. 20050018201 on Jan. 27, 2005, the disclosures of which are incorporated by reference herein in their entireties. It will thus be appreciated that those skilled in the art will be able to devise numerous systems, arrangements and methods which, although not explicitly shown or described herein, embody the principles of the invention and are thus within the spirit and scope of the present invention. In addition, to the extent that the prior art knowledge has not been explicitly incorporated by reference herein above, it is explicitly being incorporated herein in its entirety. All publications referenced herein above are incorporated herein by reference in their entireties.

What is claimed is:

1. An apparatus, comprising:
at least one first arrangement which is configured to generate a magnetic field;
at least one second arrangement coupled to the at least one first arrangement and configured to receive at least one first electro-magnetic radiation from a sample to generate at least one second electro-magnetic radiation, wherein the at least one second arrangement includes at least one surface that is at least partially reflective, and wherein the magnetic field controls a motion of the at least one surface; and
at least one third interferometric arrangement which is configured to receive the at least one second electro-magnetic radiation from the at least one second arrangement and at least one third electro-magnetic radiation from a reference.

2. The apparatus according to claim 1, further comprising at least one fourth processing arrangement which is configured to generate at least one image of the sample as a function of the second and third electro-magnetic radiations.

3. The apparatus according to claim 1, wherein the at least one first arrangement generates the magnetic field which controls the at least one surface of the at least one second arrangement to controllably direct the at least one first electro-magnetic radiation to the sample.

4. The apparatus according to claim 3, further comprising at least one fourth processing arrangement which is configured to generate at least one image of the sample as a function of the controllable directing of the at least one first electro-magnetic radiation to the sample.

5. The apparatus according to claim 4, wherein the at least one image includes at least one of a two-dimensional cross-section or a three-dimensional volume.

6. The apparatus according to claim 1, further comprising at least one focusing arrangement which is configured to focus at least one of the at least one first electro-magnetic radiation or at least one second electro-magnetic radiation to generate at least one focused radiation.

7. The apparatus according to claim 6, wherein the at least one focused radiation is received by at least one optical fiber.

8. The apparatus according to claim 6, wherein the least one focusing arrangement includes a GRIN lens which is connectable to at least one fiber.

9. The apparatus according to claim 8, wherein the GRINS lens is connected to the at least one fiber using a substance which matches a refractive index of the GRIN lens with a refractive index of the at least one fiber.

10. The apparatus according to claim 1, wherein the first and second arrangements are provided in an endoscope which includes a portion to be inserted into at least anatomical structure, and wherein the portion is configured to provide the at least one first electro-magnetic radiation to the sample.

11. The apparatus according to claim 10, further comprising a further arrangement which is configured to provide a particular voltage to the at least one first arrangement so as to generate the magnetic field, and wherein the particular voltage is less than 10V.

12. The apparatus according to claim 10, wherein the first and second arrangements are provided through at least one port of the endoscope.

13. The apparatus according to claim 10, wherein the first and second arrangements and the endoscope are provided in a dual-lumen sheath.

14. The apparatus according to claim 1, wherein the at least one first electro-magnetic radiation has at least one wavelength that changes over time.

15. The apparatus according to claim 12, further comprising at least one fourth processing arrangement which is configured to generate at least one image of the sample as a function of at least one of the at least one wavelength, the at least one second electro-magnetic radiation or the at least one third electro-magnetic radiation.

16. The apparatus according to claim 1, further comprising at least one detection arrangement which includes at least one spectrally separating unit which is configured to detect a plurality of wavelengths of at least one further radiation provided by the at least one third interferometric arrangement.

17. The apparatus according to claim 14, further comprising at least one fourth processing arrangement which is configured to generate at least one image of the sample as a function of at least one of the plurality of wavelengths, the at least one second electro-magnetic radiation or the at least one third electro-magnetic radiation.

18. The apparatus according to claim 12, further comprising at least one fourth arrangement which is configured to generate at least one image of the sample and provide further radiation for treating at least one portion of the sample being imaged.

19. The apparatus according to claim 1, further comprising a multiple-axis mirror arrangement, wherein the at least one first arrangement comprising a plurality of coils configured to control the multiple-axis mirror arrangement, and wherein the magnetic field includes at least two independent magnetic fields.

20. The apparatus according to claim 1, further comprising a microelectro-mechanical systems (MEMS) mirror arrangement and a magnet coupled to the MEMS mirror arrangement.

21. An apparatus, comprising:
at least one first arrangement which is configured to generate a magnetic field; and
at least one second arrangement coupled to the at least one first arrangement and configured to receive at least one first electro-magnetic radiation from an energy-generating arrangement to generate at least one second electro-magnetic radiation, wherein the at least one second arrangement includes at least one surface that is at least partially reflective, and wherein the magnetic field controls a motion of the at least one surface, wherein the at least one second electro-magnetic radiation effects a structure of the sample.

22. The apparatus according to claim 21, wherein the at least one second arrangement receives at least one third electro-magnetic radiation from the sample, and further comprising at least one third interferometric arrangement which is configured to receive the at least one third electro-magnetic radiation from the at least one second arrangement and at least one fourth electro-magnetic radiation from a reference.

23. The apparatus according to claim 22, further comprising at least one fourth processing arrangement which is configured to generate at least one image of the sample as a function of the third and fourth electro-magnetic radiations, and to control an amount, a path or a location on or in the sample of the at least one second electro-magnetic radiation as a function of at least one characteristic of the at least one image.

24. The apparatus according to claim 23, wherein the second and third electro-magnetic radiations are provided via the at least one surface.

25. The apparatus according to claim 21, further comprising at least one fourth arrangement which is configured to generate at least one image of the sample and provide further radiation for treating at least one portion of the sample being imaged.
